(19) United States
(12) Patent Application Publication
(10) Pub. No.: US 2008/0278619 A1
(43) Pub. Date: Nov. 13, 2008

(54) IMAGING DEVICE

(75) Inventor: Hironao Otsu, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/167,539

(22) Filed: Jul. 3, 2008

Related U.S. Application Data
(63) Continuation of application No. PCT/JP2007/071056, filed on Oct. 29, 2007.

(30) Foreign Application Priority Data
Nov. 7, 2006 (JP) 2006-301935

(51) Int. Cl. H04N 5/232

(52) U.S. Cl. 348/349; 348/E05.042

(57) ABSTRACT

In a present imaging device, an optical image formed through a lens group from a subject is converted into an imaging signal by an imaging element and a focused area is detected by a focused area detection portion. Optical displacement or physical movement of the lens group is detected by a focus lens movement detector and an adjustment stage of the lens group is determined by a focused stage determination portion based on a detection signal output from this. Based on the determination result, the focused area of the imaging signal is automatically enlarged and output.

### CROSS-REFERENCE TO RELATED APPLICATIONS

This is a Continuation Application of PCT Application No. PCT/JP2007/071056, filed Oct. 29, 2007, which was published under PCT Article 21(2) in Japanese.

This application is based upon and claims the benefit of priority from prior Japanese Patent Application No. 2006-301935, filed Nov. 7, 2006, the entire contents of which are incorporated herein by reference.

### BACKGROUND OF THE INVENTION

1. Field of the Invention

This invention relates to an imaging device and more particularly to an imaging device that converts a focused area of an image signal into a preset number of pixels and displays an image.

2. Description of the Related Art

The technique associated with a moving body tracking device in which a signal of a specified area of a photoelectric conversion element is read and the specified area is displayed on a display circuit based on a specified area specifying signal from an area specifying circuit by use of a focused point detection circuit is disclosed in Jpn. Pat. Appln. KOKAI Publication No. H5-145822, for example. The moving body tracking device described in Jpn. Pat. Appln. KOKAI Publication No. H5-145822 is characterized by including an imaging optical system, a photoelectric conversion element that converts a subject image through the imaging optical system into an image signal, frequency detection means for extracting a specified frequency component from an output signal of the photoelectric conversion element, focus area setting means for setting a focus area, adding means for calculating an added value for each row of the photoelectric conversion element in a tracking area wider than the focus area, first storage means for storing the added value of the row containing the focus area for each row, second storage means having capacity capable of storing the added values of all of the rows in the tracking area, for storing the added values for an area in which a correlation operation is performed and storing the specified frequency component in a space area, tracking means for performing a correlation operation based on the added values stored in the first and second storage means to perform a tracking operation, and focus detection means for detecting a focus based on the specified frequency component stored in the second storage means for the focus area tracked by the tracking means.

On the other hand, in Jpn. Pat. Appln. KOKAI Publication No. H7-143388, the technique associated with a video camera that subjects a video signal to an image process according to the degrees of focusing, defocusing and permits a photographer to see the thus processed image via an electronic viewfinder (which is hereinafter simply referred to as an EVF) is disclosed. The video camera is characterized by including an image forming position variable photographing lens system, a photoelectric conversion element on which a subject image captured by the photographing lens system is formed, video signal generating means for generating a video signal of the subject image from an output signal of the photoelectric conversion element, focus detection means for detecting a focusing state of the subject image formed on the photoelectric conversion element, image processing means for subjecting the video signal to an image process according to the degrees of focusing, defocusing and defocusing of the subject image based on the detection result of the focus detection means, and an electronic viewfinder that displays the subject image after the image process based on the video signal subjected to the image process by the image processing means.

### BRIEF SUMMARY OF THE INVENTION

Recently, it has becomes the trend to provide an EVF in an electronic imaging device. However, the resolution of an image displayed on the EVF is insufficient in many cases in comparison with a video signal output from the imaging device or an image signal recorded on the imaging device. Therefore, it is difficult for a photographer to attain a highly precise focus while watching the display of the EVF.

Therefore, it is requested to provide a function of assisting focus adjustment at the time of fine focus adjustment. Further, the function that does not force the photographer to perform a troublesome operation when the focus assist function is utilized is idealistic.

In the moving body tracking device described in Jpn. Pat. Appln. KOKAI Publication No. H5-145822, the technique for displaying a focus area on the display circuit is described and it is described that the focus area is subjected to moving-body-tracking. However, there is a case where the photographer wants to display a focus area and a case where he wants to display a whole portion of an image frame (effective pixel area) and the description of switching of the display image frames is not made in Jpn. Pat. Appln. KOKAI Publication No. H5-145822.

On the other hand, in the video camera described in Jpn. Pat. Appln. KOKAI Publication No. H7-143388, the photographer can find out the focusing degree by watching a video signal processed according to the focusing degree through the EVF. Further, as a concrete example of the video signal process, it is described that (1) it is blurred, (2) it is mosaicked, (3) it is shifted in a belt form, (4) the brightness thereof is changed, (5) it is rotated and displayed, (6) dots are displayed, (7) a difference in level of a luminance signal is reduced on a whole portion or part of a screen.

However, in the video camera described in Jpn. Pat. Appln. KOKAI Publication No. H7-143388, deterioration in video information of any one of 1 to 7 is displayed on the EVF accompanied by the video signal process. It is idealistic for the photographer to judge not only focus information at the focus adjustment time but also make overall image judgment at the same time as focus adjustment.

Further, generally, the photographer wants to perform an operation to display a sensual focused area based on not only the focusing degree but also the style of the photographer. That is, evaluation of focusing for the photographer is natural image quality closer to its appearance rather than image quality conversion and it is desirable to be specific.

Therefore, an object of this invention is to provide an imaging device capable of distinguishing between timing at which a focused area is enlarged and displayed and timing at which a whole video image frame portion (effective pixel area) is displayed and performing focus adjustment with image quality that looks natural to the photographer without forcing the photographer to perform a troublesome operation of switching display image frames or the like.

It is therefore an object of the present invention to provide an imaging device comprises: an optical focusing portion which adjusts a focus and forms an optical image from a subject; an imaging element which converts the optical image into an imaging signal; an image processing portion which forms an image signal from the imaging signal; a pixel-number conversion portion capable of converting at least a partial area of the image signal into a preset number of pixels; an image display portion which displays at least the partial area of the image signal; a focused area detection portion which detects a focused area based on a specified frequency component from the image signal; a focusing portion detector which detects physical movement of the optical focusing portion; and a focused stage determination portion which determines an adjustment stage of the optical focusing portion based on a focusing portion detection signal output from the focusing portion detector; wherein the focused stage determination portion which automatically converts the focused area of the image signal into a preset number of pixels and displays the image on the image display portion when the physical movement of the optical focusing portion is detected by the focusing portion detector for a preset movement time or longer.

### BRIEF DESCRIPTION OF THE SEVERAL VIEWS OF THE DRAWING

FIG. 1 is a block diagram showing the configuration of an imaging device according to a first embodiment of this invention.

FIG. 2 is a view showing one example of an image at a general focus rough adjustment stage.

FIG. 3 is a view showing one example of an image at a fine focus adjustment stage according to the first embodiment of this invention.

FIG. 4 is a view showing one example of a focused cell selection frame according to the first embodiment of this invention.

FIG. 5 is a view showing one example of an image at a focus adjustment completion stage according to the first embodiment of this invention.

FIG. 6 is a flowchart for illustrating an operation of a focused stage determination portion according to the first embodiment of this invention.

FIG. 7 is a block diagram showing the configuration of an imaging device of an interchangeable lens system according to the first embodiment of this invention.

FIG. 8 is a block diagram showing the configuration of an imaging device of an interchangeable EVF system according to a second embodiment of this invention.

### DETAILED DESCRIPTION OF THE INVENTION

There will now be described embodiments of this invention below with reference to the drawings.

### First Embodiment

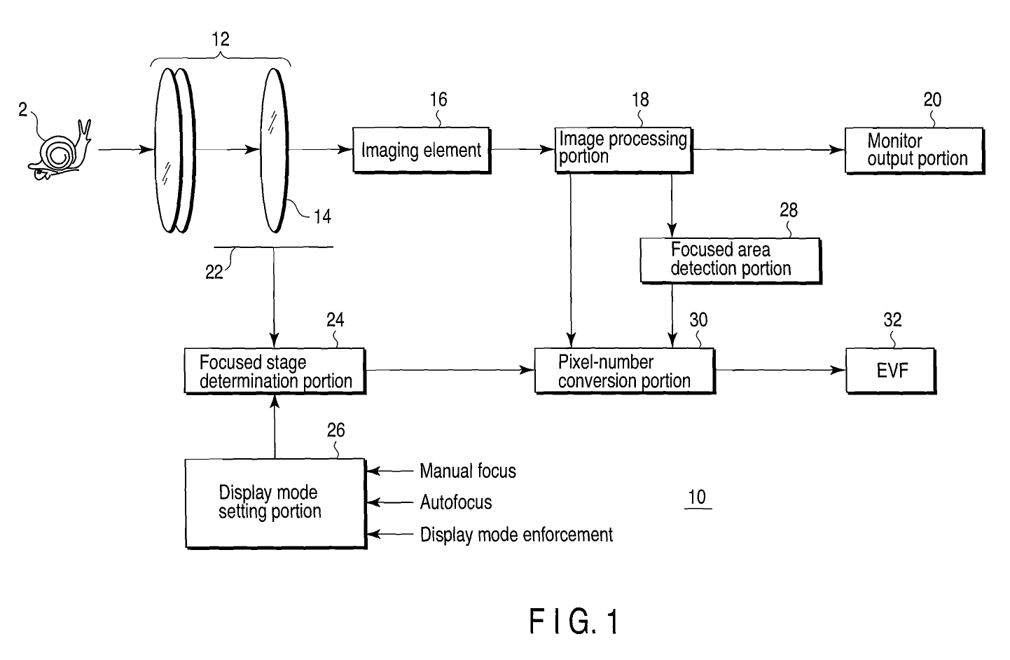

FIG. 1 is a block diagram showing the configuration of an imaging device according to a first embodiment of this invention.

In FIG. 1, the imaging device is configured by a lens group (optical focusing portion) 12 containing focus lenses 14 to input a subject 2 as an optical image to an imaging element, an imaging element 16 that converts an optical image into an imaging signal, an image processing portion 18 that generates an image signal from the imaging signal, a pixel-number conversion portion 30 that converts at least a partial area of the image signal into a pixel number to be input to an EVF (image display portion) 32, a focused area detection portion 28 that detects a focused area based on the high-frequency component of the image signal and selects or extracts the focused area, a focus lens movement detector (focusing portion detector) 22 that detects the movement of the focus lenses 14, a focused stage determination portion 24 that determines a focus adjustment stage (coarse focus adjustment stage, fine focus adjustment stage, focus adjustment completion stage) based on stationary time or movement time of a focus lens movement detection signal output from the focus lens movement detector 22, a display mode setting portion 26 connected to the focused stage determination portion 24 and capable of setting a manual focus mode, autofocus mode and other forcible display modes, and a monitor outputting portion 20 that can display a whole image frame portion (effective pixel area [effective area]) based on a video signal output from the image processing portion 18.

The lens group 12 including the focus lenses 14 is received in a lens barrel that shields natural light, for example. The lens group 12 may be either an interchangeable lens or fixed lens. Further, the focus lenses 14 contain not only a single lens for focus adjustment but also all of lenses that influence focusing. For example, a lens other than the focus lens may be contained in the focus lenses in a case where it is an inner focus lens, a case where a zoom lens influences focusing or the like.

The subject 2 is input as an optical image to the imaging element 16 via the lens group 12 including the focus lenses 14. In this case, in the lens barrel that receives the lens group 12, a lens iris, various types of optical filters (low-pass optical filter, infra-red cut filter, ND filter, cross filter) and the like may be provided. The optical image is converted into an imaging signal by the imaging element 16.

As the imaging element 16, all of imaging elements such as an interlace CCD, progressive CCD, MOS image sensor, amorphous image tube and the like that convert an optical image into an electrical signal are considered. The imaging element can be used irrespective of moving images, still images and measurement. An imaging signal output from the imaging element 16 is subjected to various image processes (white balance, luminance creation matrix, chroma creation matrix, color reproduction adjustment, luminance gradient correction, enhancement correction, noise canceling filter, brightness adjustment, black adjustment, formation of various image formats of HD-SDI standard or the like) or the like by the image processing portion 18 and supplied to the monitor outputting portion 20. In this case, an image compression processing, video signal recording portions and the like may be contained in the image processing portion 18.

Further, it is general that the focus lens movement detector 22 is contained in the lens barrel described before. As one example of the focus lens movement detector 22, a magnetic sensor that is integrally set with the focus lens reads a magnetic tape attached along the focus lens movement range in the lens barrel and acquires present focus lens position information. Alternatively, an optical pickup device may read an optical information plate attached along the focus lens movement range in the lens barrel.

In a case where a focus lens driving system is a stepping motor or the like, detection itself can be omitted by using the stepping motor drive signal itself as a focus lens movement detection signal. Further, in a case where the lens position is not moved and the lens shape is displaced to change the optical path length, it becomes necessary to set an actuator that measures the lens shape or use an electrical signal to displace the shape as a focus lens movement detection signal without reading position information of the lens. A case wherein the focus lens movement detector is disposed outside the lens barrel is explained later.

Here, the focused area detection portion 28 is explained.

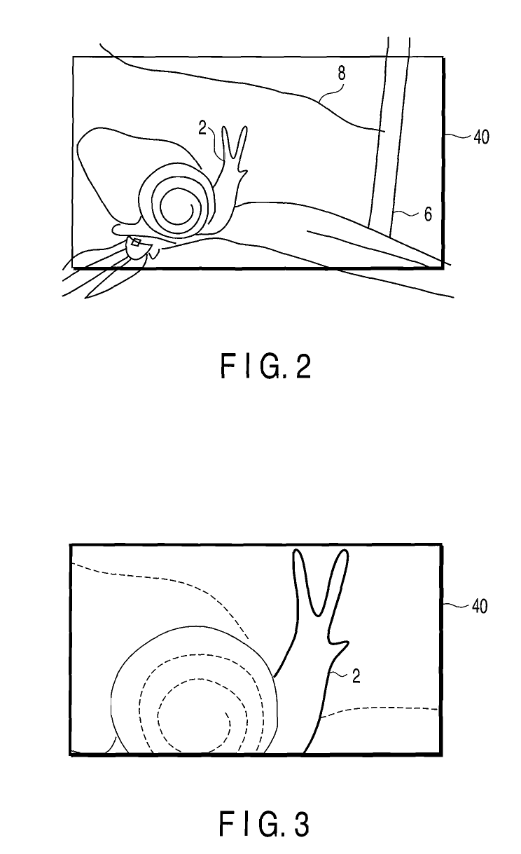

For example, as shown in FIG. 2, the focused area detection portion 28 extracts a high-frequency component of luminance close to a Nyquist frequency of the image processing portion 18 from the whole portion of an image frame 40 of EVF display. It detects, enlarges and displays a focused area based on the extracted high-frequency component as shown in FIG. 3.

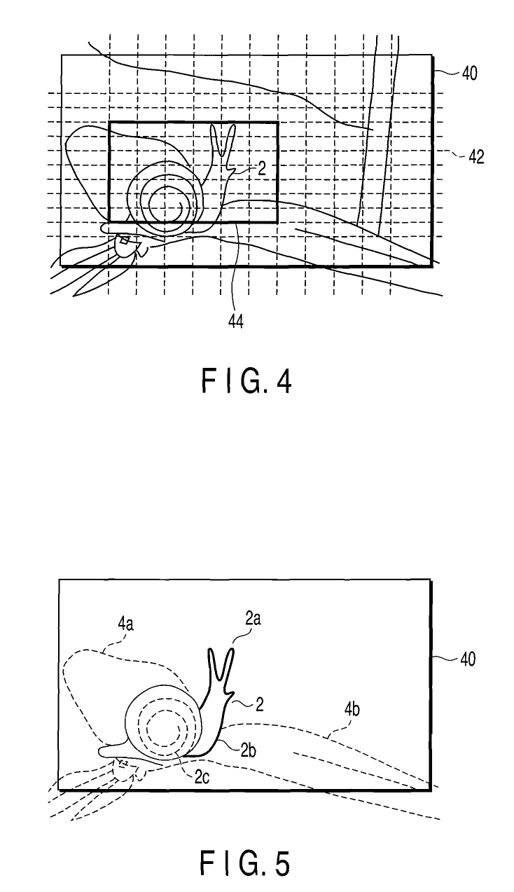

Alternatively, as shown in FIG. 4, 10×10 cells by cell dividing ruled lines indicated by broken lines in the same drawing are set near the center of the EVF-display image frame (which is simply referred to as an image frame) 40 and a focused cell selection frame 44 configured by 7×6 cells and having an aspect ratio that substantially coincides with the EVF-display image frame 40 is automatically selected based on detection of the focused area. Then, the focused cell selection frame 44 may be enlarged and displayed as shown in FIG. 3.

In this case, noise canceling for focused area detection may be provided separately from noise canceling for a video signal so as not to cause noises contained in the image to be erroneously regarded as the high-frequency component. Further, in order to prevent a high-luminance lead-in phenomenon in the focused area due to a streetlight or the like lying in the low-illumination subject, a high-luminance clip circuit may be inserted for luminance contrast or gradation correction may be inserted for luminance contrast. Further, in a case where a focused amount does not reach a preset amount even in an area in which the largest number of high-frequency components of luminance are contained, it may be permissible to determine that no focused area is present.

In the pixel-number conversion portion 30, the number of pixels of the whole portion of the image frame 40 or the number of pixels of the focused area is pixel-number-converted into the number of pixels required for the EVF 32 and output to the EVF 32. Further, in a case where the EVF 32 is fixed on the main body of the imaging device, the number of pixels of the focused area may be previously fixed equal to the number of pixels of the EVF 32.

Next, the focused stage determination portion 24 shown in FIG. 1 is explained.

In the focused stage determination portion 24, for example, a movement signal due to a focus lens movement detection signal output from the focus lens movement detector 22 or a stationary signal is input and a focus adjustment stage (coarse focus adjustment stage, fine focus adjustment stage, focus adjustment completion stage) is determined.

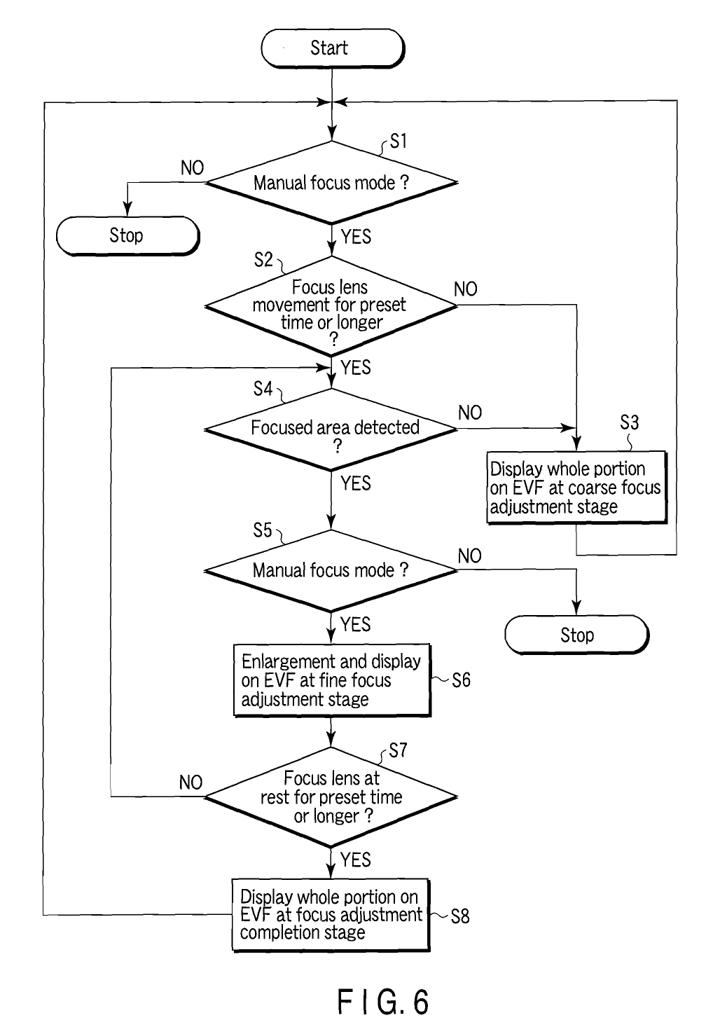

Now, the operation of the focused stage determination portion 24 is explained with reference to the flowchart of FIG. 6.

It is assumed that the focused stage determination portion 24 functions at the manual focus mode time and the focused stage determination portion 24 is stopped at the autofocus mode time. When the present sequence is started, first, it is determined in step S1 whether the manual focus mode is set or not. In this case, if the manual focus is set, step S2 is performed and if the manual focus mode is not set, the present sequence is terminated.

If the manual focus is set in step S1, it is determined in the following step S2 whether or not the focus lens 14 has moved for a preset time or longer. This is determined based on whether or not the movement signal of the focus lens 14 is detected for a preset time or longer by the focus lens movement detector 22. As a result, when the movement signal of the focus lens 14 is not detected for a preset time or longer, it is determined that the coarse focus adjustment stage is set. Then, step S3 is performed and the whole portion of the image frame 40 is kept displayed on the EVF 32 as shown in FIG. 2, for example.

On the other hand, if the movement signal of the focus lens 14 is detected for a preset time or longer in the sep S2, step S4 is performed and whether a focused area is detected or not is determined. At this time, if the focused area is detected, it is determined that the fine focus adjustment stage is set. In this case, in step S5, the manual focus mode is determined again. At this time, if the manual focus mode is not set, the present sequence is terminated. On the other hand, if the manual focus mode is set, step S6 is performed and the focused area (focused cell selection frame 44) is enlarged and displayed on the EVF 32 as shown in FIG. 3, for example.

On the other hand, if a focused area is not detected in step S4 even when the movement signal of the focus lens 14 is detected for a preset time or longer in step S2, step S3 is performed. Then, it is determined that the coarse focus adjustment stage is still set and the whole portion of the image frame 40 is displayed on the EVF 32 as shown in FIG. 2.

Further, even after it is determined that the fine focus adjustment stage is set and the focused area is enlarged and displayed on the EVF 32, whether or not the stationary signal of the focus lens 14 is detected for the preset time or longer is determined in step S7. At this time, if detection of the stationary signal is made within the preset time, step S4 is performed again and a focused area is detected. As the detection result, if the focused area is lost during the fine focus adjustment, step S3 is performed, the coarse focus adjustment stage is set again and the whole portion of the image frame 40 is displayed on the EVF 32 as shown in FIG. 2.

On the other hand, if the stationary signal of the focus lens 14 is detected for the preset time or longer in step S7 via the fine focus adjustment stage of step S6, it is determined that the focus adjustment completion stage is set. Therefore, step S8 is performed and the whole portion of the image frame 40 is displayed on the EVF 32 again as shown in FIG. 5, for example. After this, step S1 is performed.

Further, if the photographer changes the modes from the manual focus mode to the autofocus mode during the process of the sequence, the present sequence is stopped and the whole portion of the image frame is immediately displayed on the EVF 32.

Next, the explanation is additionally made from the viewpoint of the user interface based on the flowchart of FIG. 6 with reference to FIG. 2, FIG. 3 and FIG. 5.

First, the photographer first respectively sets or adjusts various photographing conditions (lens iris, exposure period, ND filter, gain, frame rate, zoom of an imaging image frame) of the imaging device. Next, the photographer determines the imaging image frame with respect to the subject 2 and starts coarse focus adjustment with respect to a certain marked subject 2 lying in the imaging image frame. Then, the rough contour of an imaginary image is generated in the imaging image frame 40 as shown in FIG. 2. When the focus is coarsely adjusted, a focused area is detected by the focused area detection portion 28. Then, the focused area is automatically popped up in the image frame 40 as shown in FIG. 3.

At this time, the photographer can finely adjust the focus and can form an image with specific detail representation associated with the marked subject 2. Since it is determined that fine focus adjustment is being performed as long as the focus lens 14 is kept moved, a marked subject is kept enlarged and displayed on the EVF 32.

In FIG. 3 and FIG. 5, thick solid lines in the drawing represent a so-called just focus state and thin lines represent that it is focused to a certain extent. Further, broken lines represent a soft focus. Then, it is understood that a scene shown in FIG. 5 is portrait photographing which photographs the subject 2 by forming an image with the shallow depth of field. In the scene shown in FIG. 5, the focus points lie on eyes 2a and the upper half part 2b of the body of a helix which is the subject 2. Further, a helix (a spiral-form pattern of a shell carried on the back) 2c and two leaves 4a and 4b are soft-focused.

A rod-like shadow 6 and linear stain 8 on the background of the subject 2 which the photographer can see in the scene of FIG. 2 are defocused (out of focus) and erased to a level at which they become inconspicuous in FIG. 5. Then, the two spread leaves 4a and 4b look like wings and a fantastic image (photograph) in which the helix looks as if it flies in the air is created.

Thus, it should be assumed that the imaged image is not necessarily realistic with respect to the subject and abstract representation due to the intention of the photographer is incorporated in many cases.

Further, it is natural for the focused area to be changed during the fine focus adjustment and the focused area image frame enlarged and displayed on the EVF is updated as required together with the fine focus adjustment. Further, since the marked subject is not always set at rest, the property that the focus area performs moving-body-tracking becomes important. The focused area detection portion shown in FIG. 1 follows the high-frequency component of luminance and is not limited only to a case wherein part of the area is fixed and enlarged.

If the fine focus adjustment is completed, the focus lens is naturally set at rest for a preset time or longer and, at this time, the focus adjustment completion is determined according to the flowchart of FIG. 6. The whole portion of the image frame 40 is displayed on the EVF 32 as shown in FIG. 5 together with the focus adjustment completion.

Thus, it is understood that the imaging device in the present embodiment produces an EVF environment with excellent operability when it is desired to form a delicate and tricky image associated with the focus of the subject based on one example of creative image formation associated with the focus as shown in FIG. 5, for example.

Further, it is understood by comparing the image of FIG. 2 and the image of FIG. 5 that the image of FIG. 5 is not limited to the level of focusing, defocusing as shown in FIG. 2 and the degree of focusing from the viewpoint of the representation is one of the image forming techniques. Further, since the imaging device in the present embodiment makes it unnecessary to perform the troublesome operation of switching of enlargement and display on the EVF 32, it is characterized in that an EVF environment which is effective to make it difficult for the concentration of the photographer to be interrupted with respect to the fine focus operation is provided.

In this case, the condition that the whole portion of the image frame is displayed on the EVF 32 and the condition that the focused area is enlarged and displayed on the EVF 32 may not be limited to the flowchart of FIG. 6 if the operation is performed according to the intention of the photographer and display mode enforcement by use of a push button, cursor lever or the like is instructed in some cases in the display mode setting portion 26 shown in FIG. 1.

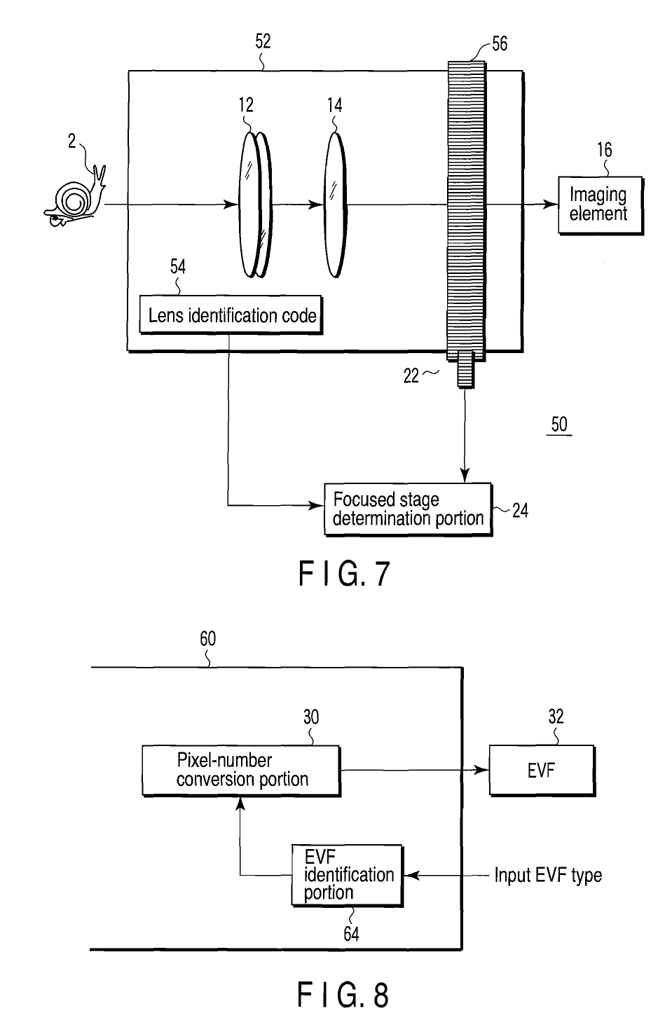

Next, one example in which the imaging device of this invention is applied to an imaging device of an interchangeable lens system is explained with reference to FIG. 7. In this case, the same reference numbers are attached to the same portions as the constituents shown in FIG. 1 and the explanation for the configurations and operations thereof is omitted.

A lens barrel 52 shown in FIG. 7 is detachably mounted on the main body (not shown) of an imaging device 50 and has an optical device connecting portion which is called a lens mount, for example. The lens barrel 52 has compatibility and has a specification in which plural types of lenses can be freely attached to one type of imaging device. In this case, since a focus lens movement detector 22 is not always previously mounted on the lens group 12, the focus lens movement detector 22 should be disposed outside the lens barrel 52.

In FIG. 7, a focus ring (focusing adjustment member) 56 previously set on the lens barrel 52 is set in a gear form with the focus lens movement detector 22 by use of uneven portions thereof. The rotation phase of the focus lens movement detector 22 shown in FIG. 7 is converted into an electrical signal and input to the focused stage determination portion 24.

If the determination operation by the focused stage determination portion 24 is performed according to the flowchart as shown in FIG. 6, it may be sufficient if the fact that the focus ring 56 is moving or at rest is input. Therefore, a lens identification code 54 shown in FIG. 7 is not always necessary. However, if the amount of the rotation phase, rotation speed and the absolute position of the focus lens 14 other than the movement and stillness of the focus lens are added to determination materials of the focused stage determination portion 24, plural types of lens identification codes (optical focusing portion identification codes) 54 as shown in FIG. 7 become necessary. The lens identification code 54 may have a specification that is automatically acquired via the optical device connecting portion when the lens is mounted on the main body of the imaging device or may be manually input by the photographer.

### Second Embodiment

Next, one example in which an imaging device of this invention is applied to an imaging device of an interchangeable EVF system is explained with reference to FIG. 8 as a second embodiment of this invention.

In this case, since the basic configuration of the imaging device is the same as the first embodiment described before in the second embodiment as will be described below, the same reference numbers are attached to the same portions and the indication in the drawings and the explanation thereof are omitted in order to avoid the repeated explanation and only different portions are explained.

An EVF 32 shown in FIG. 8 is detachably attached to the main body of an imaging device 60. The EVF 32 may be in conformity with one of the standards of HD-SDI, NTSC, PAL or can be connected to the main body of the imaging device even in a case wherein the scanning line is 1080i or 1080p or may be a nonstandard EVF. Further, the configuration of a display portion of the EVF 32 may be a CRT, liquid crystal or organic EL, for example.

Since plural types of EVFs 32 and the main body of the imaging device 60 have compatibility, an EVF type input portion is provided on the EVF itself or the main body of the imaging device 60 and the type of the EVF 32 is identified by an electronic viewfinder (EVF) identification portion 64 provided on the main body side of the imaging device 60. The EVF type is input to a pixel-number conversion portion 30 and the number of pixels suitably set for each of the plural types of EVFs is input to the EVF from the pixel-number conversion portion 30.

As described before, the imaging device of this invention can automatically distinguish between timing at which the focused area is enlarged and displayed and timing at which the whole portion of an image frame (effective pixel area) is displayed. Therefore, it can be widely applied to a case wherein an EVF having a less number of pixels than the imaging element is used in the imaging device having an EVF environment in which focus adjustment can be made with natural image quality on the appearance for the photographer without forcing the photographer to perform the troublesome operation of switching the display image frames and, for example, having an imaging element for a 4K digital cinema mounted thereon.

As described above, the embodiments of this invention are explained in detail with reference to the drawings, but the concrete configuration is not limited to the embodiments and the design modification and the like in the range which does not deviate from the essentials of this invention are contained.

Further, inventions of various stages are contained in the embodiments described before and various inventions can be extracted by adequately combining a plurality of constituents disclosed. For example, in a case where the problem described in the item of the problem to be solved by this invention can be solved and the effect described in the items of the effect of this invention can be attained even if several constituents are eliminated from all of the constituents shown in the embodiments, the configuration with the constituent eliminated can also be extracted as an invention.

According to this invention, an imaging device capable of distinguishing between timing at which a focused area is enlarged and displayed and timing at which a whole image frame portion (effective pixel area) is displayed and enhancing an EVF environment at the focus adjustment time by the photographer can be provided.

What is claimed is:

1. An imaging device comprising:
an optical focusing portion which adjusts a focus and forms an optical image from a subject,
an imaging element which converts the optical image into an imaging signal,
an image processing portion which forms an image signal from the imaging signal,
a pixel-number conversion portion capable of converting at least a partial area of the image signal into a preset number of pixels,
an image display portion which displays at least the partial area of the image signal,
a focused area detection portion which detects a focused area based on a specified frequency component from the image signal,
a focusing portion detector which detects physical movement of the optical focusing portion, and
a focused stage determination portion which determines an adjustment stage of the optical focusing portion based on a focusing portion detection signal output from the focusing portion detector,
wherein the focused stage determination portion which automatically converts the focused area of the image signal into a preset number of pixels and displays the image on the image display portion when the physical movement of the optical focusing portion is detected by the focusing portion detector for a preset movement time or longer.

2. The imaging device according to claim 1, wherein the focused stage determination portion automatically converts an effective area of the image signal into a preset number of pixels and displays the image on the image display portion when physical stillness of the optical focusing portion is detected by the focusing portion detector for a preset rest time or longer.

3. The imaging device according to claim 1, wherein the pixel-number conversion portion automatically converts an effective area of the image signal into a preset number of pixels and displays the image on the image display portion when the focused area of a preset focused amount or more is not present in the image signal.

4. The imaging device according to claim 3, wherein the effective area of the image signal is automatically converted into a preset number of pixels and the image is displayed on the image display portion irrespective of the focusing portion detection signal output from the focusing portion detector when the imaging device is set in an automatic focusing mode.

5. The imaging device according to claim 3, wherein the number of pixels of the image display portion is less than the number of pixels of the imaging element.

6. The imaging device according to claim 5, wherein the image processing portion is in conformity with an HD-SDI standard and the image display portion is in conformity with an NTSC standard.

7. The imaging device according to claim 5, wherein the image processing portion is in conformity with an HD-SDI standard and the image display portion is in conformity with a PAL standard.

8. The imaging device according to claim 3, wherein the imaging element has the number of pixels larger than the number of pixels which is in conformity with a 4K digital cinema.

9. The imaging device according to claim 8, wherein the image processing portion is in conformity with a 4K digital cinema and the image display portion is in conformity with an HD-SDI standard.

10. The imaging device according to claim 8, wherein the image processing portion is in conformity with a 4K digital cinema and a scanning line of the image display portion has 1080i or 1080p.

11. The imaging device according to claim 3, wherein the focused area is configured by a focused cell selection frame selected based on the focused area detection portion and an aspect ratio of the focused cell selection frame is substantially equal to an aspect ratio of the image display portion.

12. The imaging device according to claim 11, wherein the image display portion is fixed on a main body of the imaging device and the number of pixels of the image display portion and the number of pixels of the focused area are equally fixed.

13. The imaging device according to claim 3, in which the image display portion is configured by a CRT image display portion and the CRT image display portion is detachably mounted on a main body of the imaging device and which further comprises an electronic viewfinder identification portion which identifies the number of scanning lines which the CRT image display portion can display in the main body of the imaging device.

14. The imaging device according to claim 3, in which the image display portion is configured by a liquid crystal image display portion and the liquid crystal image display portion is detachably mounted on a main body of the imaging device and which further comprises an electronic viewfinder identification portion which identifies the number of pixels which the liquid crystal image display portion can display in the main body of the imaging device.

15. The imaging device according to claim 3, in which the image display portion is configured by an organic EL image display portion and the organic EL image display portion is detachably mounted on a main body of the imaging device and which further comprises an electronic viewfinder identification portion which identifies resolution with which the organic EL image display portion can display in the main body of the imaging device.

16. The imaging device according to claim 3, in which the optical focusing portion is detachably mounted on a main body of the imaging device and which further comprises an optical focusing portion identification code to identify plural types of the optical focusing portions.

17. The imaging device according to claim 3, wherein the optical focusing portion is fixed on a main body of the imaging device and a stepping motor drive signal is input to the focusing portion detector.

18. The imaging device according to claim 3, wherein the optical focusing portion is fixed on a main body of the imaging device and the focusing portion detector has a magnetic sensor which reads a magnetic tape attached along a movement range of the optical focusing portion.

19. The imaging device according to claim 3, wherein the focusing portion detector is detachably mounted on the optical focusing portion and the focusing portion detector measures a position of a focus adjusting member to adjust the optical focusing portion.
